(19) United States
(12) Patent Application Publication
(10) Pub. No.: US 2005/0114858 A1
(43) Pub. Date: May 26, 2005

(54) Cancelled task management in a computer system

(75) Inventors: Marco Miller, Laval (CA); Patrick Bibeau, Laval (CA)

Correspondence Address: Sandra Beauchesne;Ericsson Canada Inc., Patent Department, 8400 Decarie Blvd., Town Mount Royal, QC, H4P 2N2, CA

(73) Assignee: Telefonaktiebolaget L M Ericsson

(21) Appl. No.: 10/720,061

(22) Filed: Nov. 25, 2003

(51) Int. Cl. G06F 9/46

(52) U.S. Cl. 718/100

(57) ABSTRACT

A method and a task scheduler for canceling a task in a computer system, wherein the task scheduler manages a plurality of tasks using at least one task queue. The task scheduler is arranged to free resources assigned to a cancelled task of the plurality of tasks when the cancelled task reaches the top of any of the at least one task queue. The method comprises steps of identifying a task from the plurality of tasks as a cancelled task, actively prioritizing the identified task to the top of its corresponding task queue and allowing the task scheduler to free resources assigned to the identified task. Optionally, the step of prioritizing may further comprises steps of setting a NextExecution parameter of the identified task to a value near zero and of notifying a memory garbage collector associated to the task scheduler that resources need to be freed.

### BACKGROUND OF THE INVENTION

1. Field of the Invention

The present invention relates to delayed tasks management in a computer system.

2. Description of the Related Art

In today's computer systems, complex software applications are developed using a series of pre-programmed functions and methods within a framework. The pre-programmed functions and methods enable the developer, while coding its own software application, to access common functionalities of the framework without having to set and control all parameters related thereto. Example of those functionalities includes Input/Output (I/O) interactions with various devices (e.g. printer, keyboard, etc.), screen display, memory management, etc. It is important to note that the pre-programmed functions and methods are designed for a wide range of uses and have different level of optimization depending on their intended purpose. In the specific case of telecommunications software application, the load on the framework is exceptionally high in some specific areas due, in part, to the great number of different tasks that need to be handled concurrently. In the present context, a task is a representation of a process having specific logical and data contents.

In the following discussion, the framework provided by Sun Microsystems under the name of Java™ 2 Software Development Kit (J2SDK), Standard Edition 1.4.2_{—}01 (at the time of the invention), hereinafter referred to as the Java™ framework, will be taken as an exemplary framework. In the Java™ framework, a functionality of task queue management is included. The task queue management functionality maintains an ordered queue of all tasks in the framework to which an execution delay has been fixed. Each task runs upon expiration of its associated delay. The task queue management functionality includes a function to cancel any active task in the Java™ framework. The Cancel function identifies the corresponding task as being cancelled and leaves the task in the queue. The task queue management functionality further includes a memory garbage collector to free resources that are not used by any active task in the computer system. The memory garbage collector looks at the task located at the head of the queue and frees resources associated therewith if the head task is identified as cancelled.

Reference is now made to the drawings wherein FIG. 1 shows an exemplary task queue 10 implementing the Java™ framework task management functionalities. The task queue 10 of FIG. 1 includes multiple active tasks, some recurrent with an associated period and some scheduled for a one-time execution. The task queue 10 further includes multiple cancelled tasks, which remained therein as mentioned earlier. Each cancelled task will be removed from the computer system once at the head of the queue. In the example of Task_B, removal from the computer system will occur between 20 and 50 seconds, depending if other tasks are added in the system before Task_B actually reached the head of the queue. In the example of Task_L, removal will only occur between 78985 and 89545 seconds.

The scenario described herein below creates a problem in, for example, highly demanding telecommunications applications when a plurality of tasks are cancelled, but are not scheduled to run soon, thus creating an undue memory usage overload on the computer system.

The present invention provides a solution to the presented problem.

### SUMMARY OF THE INVENTION

A first object of the present invention is directed to a method for canceling a task in a computer system, wherein the computer system comprises a task scheduler for managing a plurality of tasks using at least one task queue. The task scheduler is arranged to free resources assigned to a cancelled task of the plurality of tasks when the cancelled task reaches the top of any of the at least one task queue. The method comprises steps of identifying a task from the plurality of tasks as a cancelled task, actively prioritizing the identified task to the top of its corresponding task queue and allowing the task scheduler to free resources assigned to the identified task.

In an optional behavior of the present invention, the step of prioritizing may further comprises a step of setting a NextExecution parameter of the identified task to a value near zero. The step of prioritizing may yet further comprises a step of updating an Index parameter associated with the identified task in accordance with the top of its corresponding task queue. The method may yet comprise a further step of notifying a memory garbage collector associated to the task scheduler that resources need to be freed.

A second object of the present invention is directed to a task scheduler within a computer system comprising at least one task queue capable of managing a plurality of tasks, a prioritizing module and a memory garbage collector. The prioritizing module is capable of actively prioritizing a task identified as a cancelled task within the plurality of tasks to the top of its corresponding task queue. The memory garbage collector is capable of freeing resources assigned to the identified task when the identified task reaches the top of any of the at least one task queue.

In an optional behavior of the present invention, the prioritizing module of the task scheduler may be further capable of setting a NextExecution parameter of the identified task to a value near zero and of updating an Index parameter associated with the identified task in accordance with the top of its corresponding task queue. The prioritizing module of the task scheduler may yet be further capable of notifying the memory garbage collector when resources need to be freed.

### BRIEF DESCRIPTION OF THE DRAWINGS

A more complete understanding of the present invention may be had by reference to the following Detailed Description when taken in conjunction with the accompanying drawings wherein:

FIG. 1 shows an exemplary task queue implementing the Java™ framework task management functionalities in accordance with prior art;

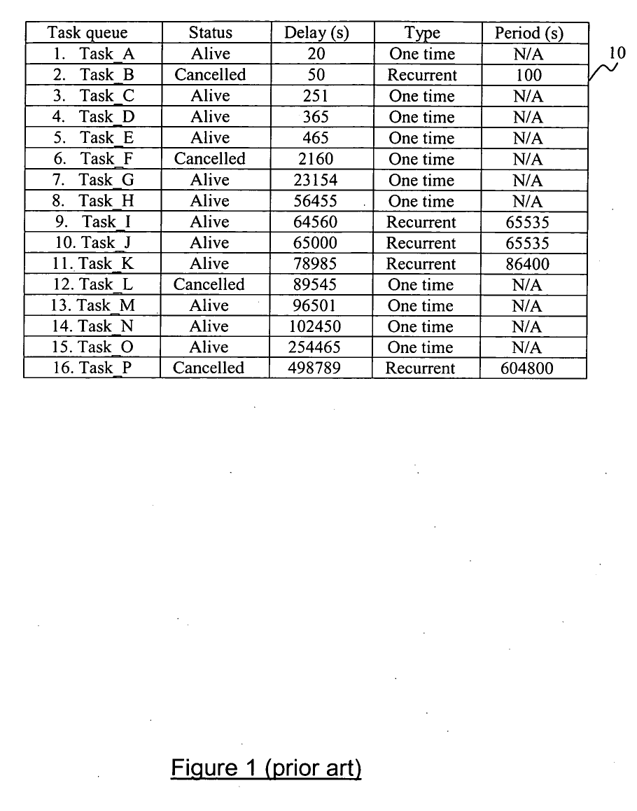

FIG. 2 shows an exemplary flow chart for canceling a task in a computer system in accordance with the teachings of the present invention; and

FIG. 3 shows a modular representation of a task scheduler arranged in accordance with the teachings of the present invention.

### DETAILED DESCRIPTION OF THE PREFERRED EMBODIMENTS

The solution provided to the problem described earlier is to create a separate management functionality for tasks, wherein new functions are created to promote tasks identified as cancelled to the top of their respective task queue, thus enabling the memory garbage collector to free resources associated therewith. This may be achieved, for instance, by assigning a NextExecution time associated with the cancelled task to a value near zero, thus actively prioritizing the task to the top of the queue. An index used by the task queue associated with the cancelled task may also be updated to reflect the prioritizing of the cancelled task.

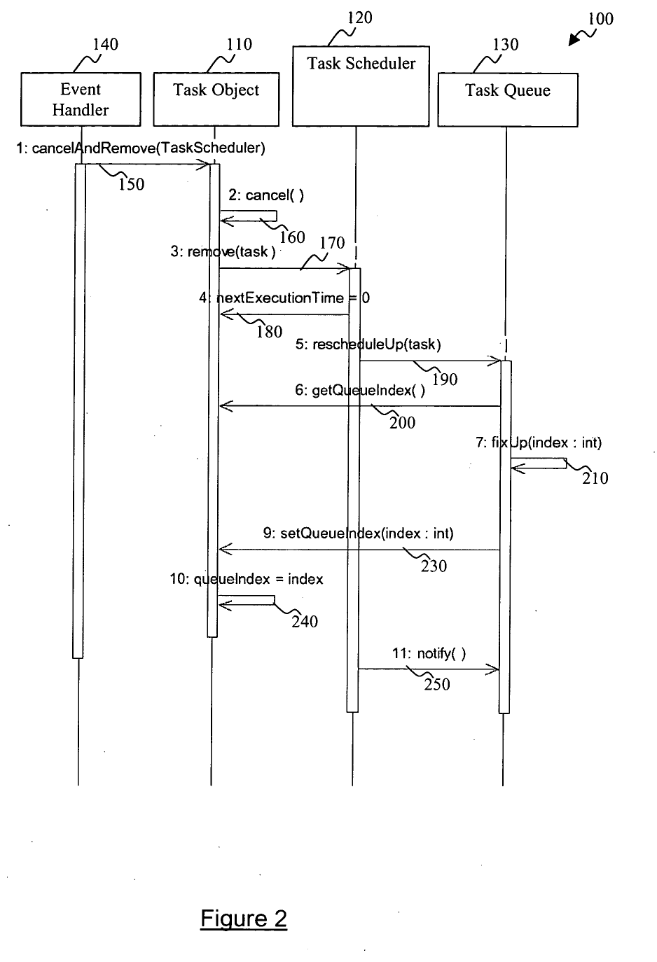

Reference is now made to FIG. 2, which shows an exemplary flow chart for canceling a task 110 in a computer system 100. In the context of the present example, the computer system 100 comprises a task scheduler 120 for managing a plurality of tasks, including the task 110, by using at least one task queue 130. FIG. 2 shows the task scheduler 120 and the task queue 130 as separate entities, but there could be some implementations where the task queue 130 is a part of the task scheduler 120. The task scheduler 120 is arranged to free resources assigned to the cancelled task 110 when it reaches the top of the task queue 130. The computer system further comprises an event handler 140, which reports decision on task creation and cancellation. The reason why task should be created or, later, cancelled is out of the scope of the present invention. However, when a decision is reached that the task 110 should be cancelled, the event handler 140 calls a function “CancelAndRemove” of the task 110, as shown on FIG. 2 at step 150. The function call of the step 150 may include a parameter (shown between brackets as “TaskScheduler”) to identify the task scheduler 120 associated to the task 110. Upon reception of the function call 150, the task 110, depending on the type of implementation of the task queue 130, may need to mark itself as cancelled (step 160). This is, for example, likely to be the case if the management functionality for tasks is developed using object oriented concepts such as encapsulation. The task 110 further notifies the task scheduler 120 that it has been cancelled (step 170). The notification of the task scheduler 120 is likely to be, again, a direct call 170 from the task 110 to a function “Remove” of the task scheduler 120. The function call of step 170 may further include a parameter (shown between brackets as “task”) to help the task scheduler 120 in identifying the task 110 being cancelled. The steps 150 to 170 represent one way of identifying that the task 110, from the plurality of tasks managed by the task scheduler 120, is to be cancelled. One skilled in the art would probably notice that the same objective could be met by exchanging messages instead of calling functions. Also, as it could be readily understood, the names of the functions and of the parameters thereof are shown only for illustrative purposes and could be changed without affecting the teachings of the present invention.

Upon reception of the notification of the step 170, the task scheduler 120 reschedules the task 110 for execution as soon as possible (step 180). In the example of FIG. 2, the step 180 is done by the task scheduler 120 setting a NextExecution parameter of the task 110 to a value of 0. The NextExecution parameter contains a decreasing timer value, usually in milliseconds, of the next execution of the task 110. Thus, setting its value to zero, or to a value near 0, actively prioritizes the task 110 to the top of the task queue 130. Since the task scheduler 120 is arranged to free resources assigned to the cancelled task 110 when it reaches the top of the task queue 130, setting the NextExecution parameter to a value near zero also allows the task scheduler 120 to free resources assigned thereto. It should be noted that the top of the task queue 130, in the present context, does not only represent the first task in the queue, but rather the tasks that are to be executed within a short period of time. For example, it can be appreciated that multiple tasks could have the same value assigned to their respective NextExecution parameter and reach the top of the task queue 130 together. Another example is to have multiple cancelled tasks ready to be, but not yet removed from the task queue 130. All those cancelled tasks could, indeed, be seen as the top of the task queue 130. It should also be noted that any type of measures could be used instead of the milliseconds to represent the value of the NextExecution parameter.

In some implementations of the present invention, the task queue 130 of the computer system 100 orders the tasks it contains by using an index maintained within each task thereof. In such a case, the index value is needed to identify tasks at the top of the task queue 130. Because of that, after the step 180, the task scheduler 120, as shown on FIG. 2 at step 190, may need to notify the task queue 130 that a modification occurred in the NextExecution parameter of the task 110. Again, the notification of the step 190 may take the form of a direct function call to “rescheduleUp” as shown on FIG. 2. The function call of the step 190 may include a parameter (shown between brackets as “task”) to identify the task 110 for which the modification occurred. Upon reception of the notification of the step 190, the task queue 130 updates the index parameter associated with the task 110 in accordance with the top of the task queue 130. In the example of FIG. 2, the update consists a few steps starting by a function call to “getQueueIndex” from the task queue 130 to the task 110 in order to get the current index of the task 110 (step 200). The task queue 130 then further positions (i.e. assign a new index value to) the task 110. The new value of the index parameter may be obtained in multiple ways by the task queue 130. One possibility is to go through a process similar to “bubble sort” and reorder all tasks within the task queue 130 in accordance with the value of their respective NextExecution parameter (note that the top of the task queue 130 could be represented by the highest or the lowest index value). This is shown on FIG. 2 by a fixUp step 210, which promotes the task 110 up until the NextExecution parameter thereof is smaller than the one in front of the task 110. Once the new value is established, the task queue 130 calls a “SetQueueIndex” function of the task 110 (step 230) and, thereby, passes the new index value that is now assigned to the task 110. The new index value can be assigned by using a function parameter (shown on FIG. 2 as “index”), which is likely to be an integer (identified on FIG. 2 as “: int”). The task 110, depending on the type of implementation, may further need to take a step 240 to confirm the new value of the index parameter assigned to itself by setting it appropriately. Again, an example of such implementations is likely to be developed with object oriented concepts.

As mentioned previously, the task scheduler 120 is allowed to free resources assigned to the cancelled task 110 after completion of step 180. In some implementations, the active step of freeing the resources may not be done by the task scheduler 120 and, thus, a step 250 of notifying a responsible entity may be needed. For example, step 250 could represent notifying, or waking up, a memory garbage collector associated to the task scheduler 120 or the task queue 130 or to both. In the example of FIG. 2, the task queue 130 responsible for the memory garbage collector is notified via a call to a function “Notify” of the task queue 130 that resources needs to be freed or, in other words, that the top of the task queue 130 should be examined for presence of at least one cancelled task (in the present example, the task 110).

As mentioned previously, exchanging messages instead of calling functions could lead to the same result as the example of FIG. 2. Again, the names of the functions and of the parameters shown hereinabove are only used for illustrative purposes and could be changed without affecting the teachings of the present invention.

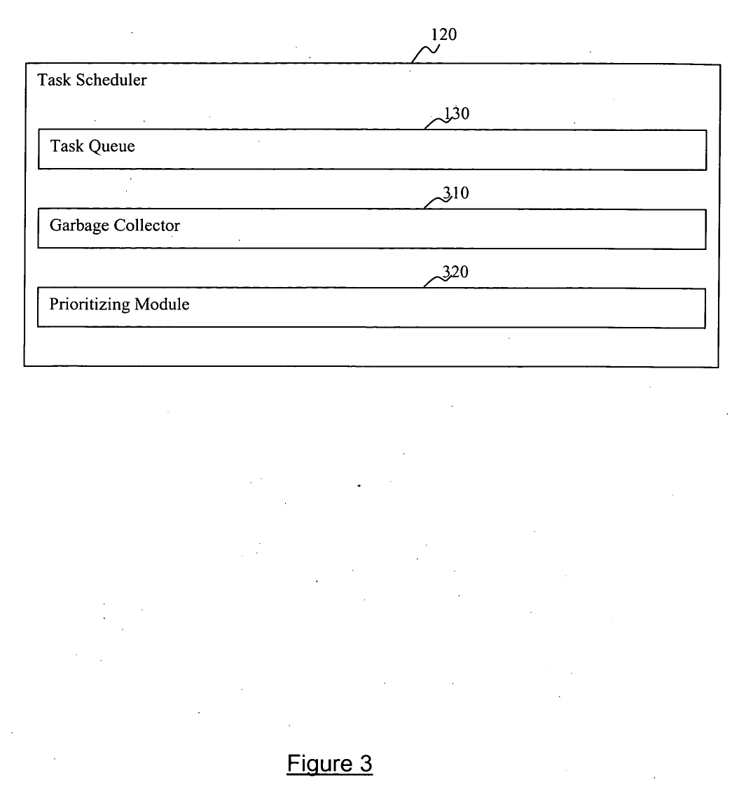

FIG. 3 shows a modular representation of the task scheduler 120. The task scheduler 120 comprises the task queue 130, a memory garbage collector 310 and a prioritizing module 320. The task queue 130, as mentioned earlier, is capable of managing a plurality of tasks. The prioritizing module 320 is capable of actively prioritizing a task within the plurality of tasks to the top of the task queue 130, wherein the task has been previously identified as a cancelled task. The prioritizing module is further capable of setting a NextExecution parameter of the identified task to a value near zero. The prioritizing module is yet further capable of updating an Index parameter associated with the identified task in accordance with the top of its corresponding task queue and of notifying the memory garbage collector that resources need to be freed. The memory garbage collector 310 is capable of freeing resources assigned to the identified task when the identified task reaches the top of the task queue 130.

The innovative teachings of the present invention have been described with particular reference to numerous exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views, and the various elements depicted are not necessarily drawn to scale.

1. A method for canceling a task in a computer system, the computer system comprising a task scheduler for managing a plurality of tasks using at least one task queue, wherein the task scheduler is arranged to free resources assigned to a cancelled task of the plurality of tasks when the cancelled task reaches the top of any of the at least one task queue, the method comprising steps of:
identifying a task from the plurality of tasks as a cancelled task;
actively prioritizing the identified task to the top of its corresponding task queue; and
allowing the task scheduler to free resources assigned to the identified task.

2. The method of claim 1, wherein the step of identifying comprises a step of calling a Cancel function associated with the identified task.

3. The method of claim 1, wherein the steps of identifying and prioritizing are performed by calling a CancelAndRemove function associated with the identified task.

4. The method of claim 1, wherein the step of prioritizing further comprises a step of setting a NextExecution parameter of the identified task to a value near zero.

5. The method of claim 4, wherein the step of prioritizing further comprises a step of updating an Index parameter associated with the identified task in accordance with the top of its corresponding task queue.

6. The method of claim 1, wherein the step of allowing further comprises notifying a memory garbage collector associated to the task scheduler.

7. A task scheduler within a computer system comprising:
at least one task queue capable of managing a plurality of tasks;
a prioritizing module capable of:
actively prioritizing a task within the plurality of tasks to the top of its corresponding task queue, wherein the task has been identified as a cancelled task; and
a memory garbage collector capable of:
freeing resources assigned to the identified task when the identified task reaches the top of any of the at least one task queue.

8. The task scheduler of claim 7, wherein the prioritizing module is further capable of setting a NextExecution parameter of the identified task to a value near zero.

9. The task scheduler of claim 7, wherein the prioritizing module is further capable of updating an Index parameter associated with the identified task in accordance with the top of its corresponding task queue.

10. The task scheduler of claim 7, wherein the prioritizing module is further capable of notifying the memory garbage collector.
